(19) United States
(12) Patent Application Publication
(10) Pub. No.: US 2008/0255892 A1
(43) Pub. Date: Oct. 16, 2008

(54) System and Method for Oil Production Forecasting and Optimization in a Model-Based Framework

(75) Inventors: Abdollah Orangi, Irvine, CA (US); William J. Da Sie, Danville, CA (US); Viktor K. Prasanna, Pacific Palisades, CA (US); Cong Zhang, Alhambra, CA (US); Amol Bakshi, Pasadena, CA (US)

Correspondence Address: CROWELL & MORING LLP;INTELLECTUAL PROPERTY GROUP, P.O. BOX 14300, WASHINGTON, DC, 20044-4300, US

(73) Assignees: The University of Southern California; Chevron U.S.A. Inc., San Ramon, CA (US)

(21) Appl. No.: 11/734,214

(22) Filed: Apr. 11, 2007

(51) Int. Cl. G06Q 99/00

(52) U.S. Cl. 705/7

(57) ABSTRACT

Systems and methods are directed to forecasting oilfield production in an integrated asset management framework and specifying conditions associated with the plurality of models. A graphical interface for generates a plurality of models that represent asset components in the oilfield, and a database stores the plurality of models. An application toolkit for analyzes at least one of the plurality of stored models based on a scenario to forecast a performance of an asset component associated with the at least one analyzed model.

### RELATED APPLICATION

This application claims a priority benefit under 35 U.S.C. §119 of Provisional Application No. 60/791,606 filed on Apr. 11, 2006, the contents of which are incorporated in its entirety by reference.

### BACKGROUND

1. Field

Systems and methods for oil production forecasting and optimization in an Integrated Asset Management (IAM) framework are disclosed.

2. Background Information

The push towards “digital oilfields” has highlighted the need for efficient decision support systems that enable the integration of a myriad of software tools for modeling, simulation, and prediction of reservoir performance. Integrated asset management (IAM) frameworks can enable systematic management of oil field assets in order to facilitate high-level optimization and decision support.

Integrated Asset Management (“IAM”) systems tie together or model the operations of many physical and non-physical assets or components of an oilfield. Examples of physical assets or components might include subterranean reservoirs, well bores connecting the reservoirs to pipe network systems, separators and processing systems for processing fluids produced from the subterranean reservoirs and heat and water injection systems. Non-physical assets or components can include reliability estimators, financial calculators, optimizers, uncertainty estimators, control systems, historical production data, simulation results, etc. Two examples of commercially available software programs for modeling IAM systems include AVOCET™ IAM software program, available from Schlumberger Corporation of Houston, Tex. and INTEGRATED PRODUCTION MODELING (IPM™) toolkit from Petroleum Experts Inc. of Houston, Tex.

IAM presents an intensive operational environment involving a continuous series of decisions based on multiple criteria including safety, environmental policy, component reliability, efficient capital, operating expenditures, and revenue. Asset management decisions require interactions among multiple domain experts, each capable of running detailed technical analysis on highly specialized and often compute-intensive applications. Technical analysis executed in parallel domains over extended periods can result in divergence of assumptions regarding boundary conditions between domains. A good example of this is pre-development facilities design while reservoir modeling and performance forecasting evaluations progress. Alternatively, many established proxy models are incorporated to meet demands of rapid decision making in an operational environment or when data is limited or unavailable.

### SUMMARY

An exemplary system for forecasting oilfield production in an integrated asset management framework is disclosed. The system comprises a graphical interface for generating a plurality of models that represent asset components in the oilfield and specifying conditions associated with the plurality of models. The system comprises a model database for storing the plurality of models, and an application toolkit for analyzing at least one of the plurality of stored models based on a scenario to forecast a performance of an asset component associated with the at least one analyzed model.

An exemplary method of integrated forecasting in an integrated asset management framework is disclosed. The method comprises instantiating model elements of an asset component to generate an inventory model of an asset. The method also comprises defining at least one scenario based on the inventory model, and analyzing the at least one scenario to forecast a performance of the asset.

An exemplary computer readable medium storing a program for performing a method of integrated forecasting in an integrated asset management framework is disclosed. The method comprises instantiating model elements of an asset component to generate an inventory model of an asset, defining at least one scenario based on the inventory model; and analyzing the at least one scenario to forecast a performance of the asset.

### DESCRIPTION OF THE DRAWINGS

In the following, exemplary embodiments will be described in greater detail in reference to the drawings, wherein:

FIG. 1 illustrates a schematic diagram of a forecasting toolkit in accordance with an exemplary embodiment;

FIG. 2 illustrates a root folder view of a graphical interface in accordance with an exemplary embodiment;

FIG. 3 illustrates a schematic diagram of an integrated forecasting workflow in accordance with an exemplary embodiment; and

FIG. 4 illustrates a production forecasting menu of a graphical interface in accordance with an exemplary embodiment.

### DETAILED DESCRIPTION

An exemplary goal of an Integrated Asset Management (IAM) framework for use in an oil and gas industry application are twofold. First, from an end users' perspective, it should offer a single, easy-to-use user interface for specifying and executing a variety of workflows from reservoir simulations to economic evaluation. Second, from a software perspective, the IAM framework should facilitate seamless interaction of diverse and independently developed applications that accomplish various sub-tasks in an overall workflow. For example, the IAM framework should pipe the output of a reservoir simulator running on one machine to a forecasting and optimization toolkit running on another and in turn piping its output to a third piece of software that can convert the information into a set of reports in a specified format.

To accomplish these objectives, the IAM framework can be based on a model-integrated system design. In the model-integrated system design, the IAM can be configured to define a domain-specific modeling language for structured specification of all relevant information about an asset being modeled. The resulting model of the asset captures information about many physical and non-physical aspects of the asset and stores it in a model database. The model database can be in a canonical format that can be accessed by any of a number of tools in the IAM framework. The tools can be accessed through well-defined application program interfaces (APIs).

In a model-based IAM framework, the asset model acts as a central coordinator of information access and data transformation. The asset model interfaces each tool with the model database such that the database enables indirect coupling of disparate applications by allowing them to collaboratively work together in a common context of the asset model. In this manner, the asset model provides a front-end modeling environment to the end user. The front-end modeling environment enables the asset model to be defined and modified, and contains a mechanism to allow the invocation of one or more integrated tools that act on different parts of the asset model.

The IAM framework can also be configured as a service oriented architecture (SOA). The SOA is a style of designing software systems by packaging functionalities as services that can be invoked by any service requester. An SOA typically implies a loose coupling between modules by wrapping a well-defined service invocation interface around a functional module. The SOA hides the details of the module implementation from other service requesters. This feature can enable the IAM framework to provide software reuse and localizes changes to a module implementation so that the changes do not affect other modules as long as the service interface is unchanged. Web-services form an attractive basis for implementing service-oriented architectures for distributed systems. Web services can rely on open, platform-independent protocols and standards, and allow software modules to be accessible over the Internet.

When the service-oriented architecture is adopted for designing an IAM framework, every component, regardless of its functionality, resource requirements, language of implementation, among others, provides a well-defined service interface that can be used by any other component in the framework. The service abstraction provides a uniform way to mask a variety of underlying data sources (e.g., real-time production data, historical data, model parameters, and reports) and functionalities (e.g., simulators, optimizers, sensors, and actuators). Workflows can be composed by coupling service interfaces in the desired order. The workflow specification can be implemented through a graphical or textual front end and the actual service calls can be generated automatically.

An exemplary IAM framework can incorporate a number of information consumers such as simulation tools, optimizers, databases, real-time control systems for in situ sensing and actuation, and also human engineers and analysts. The data sources in the system are equally diverse, ranging from real-time measurements from temperature, flow, pressure, and vibration sensors, on physical assets such as oil pipelines to more abstract data such as simulation results, maintenance schedules of oilfield equipment, and market prices, for example.

In many workflows, intermediate processing is used for the data produced by one tool (service). This intermediate processing can include a data conversion involving a reformatting of data or more complex transformations such as unit conversions (e.g., barrels to cubic meters), and aggregation (e.g., well production to block production), for example. Specific interpolation policies could be used to fill in a data set with missing values.

Systems and methods are disclosed demonstrating an integrated production forecasting and optimization workflow. The input data set for this workflow can be divided into two main categories, such as, model information, and system and production controls, or any other suitable categories as desired. The model information can include data, such as a number, names, and properties of reservoir volume elements, location and capabilities of wells, capability of surface facilities for gas compression, water handling, and separator system, or any other suitable data as desired. The data also includes fine- or coarse-grained characterization of reservoir behavior in terms of fractional recovery curves for oil, gas, and water or any other behavioral characteristic as desired. The system and production controls can include production targets, well or block events that can influence the workflow, or any other control parameter as desired. These controls are passed to an optimization core. An exemplary objective function of the workflow can include maximize oil production. The workflow can be analyzed to meet secondary objectives that involve characteristics at the well, block, or reservoir level could also be specified depending on the particular workflow requirements and the capabilities of the optimization engine.

The framework can be configured to produce a workflow output that includes production data at a level of granularity specified by an end user, and graphs that are plotted based on the output data.

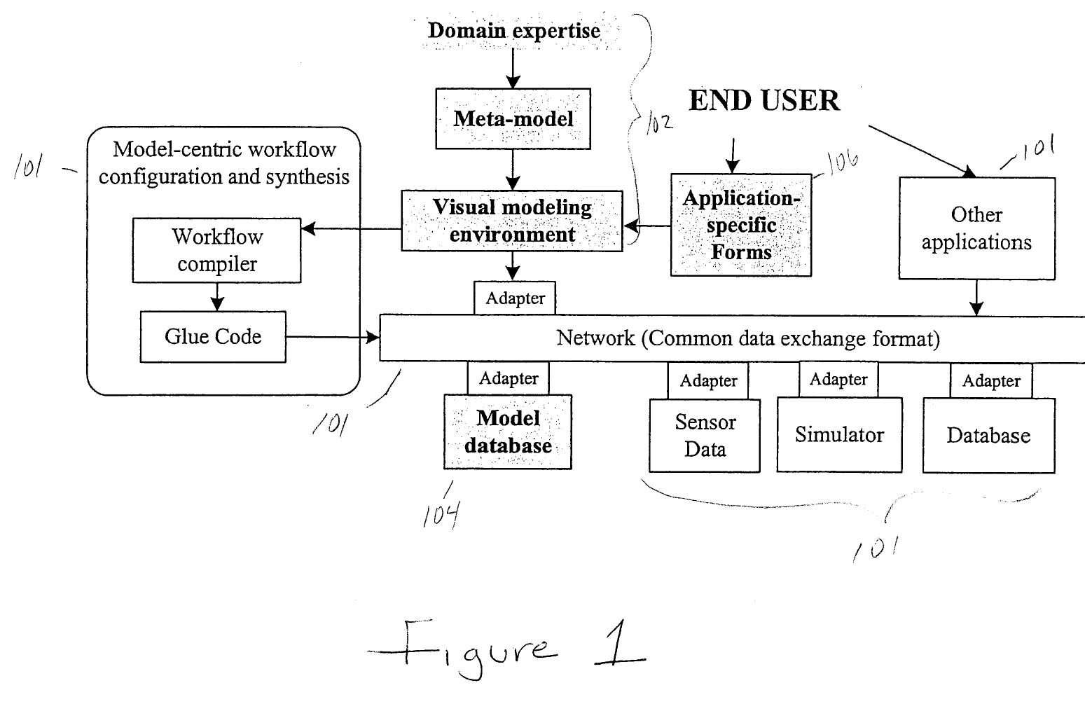

FIG. 1 illustrates a schematic diagram of an IAM framework in accordance with an exemplary embodiment. The IAM framework can be based on a graphical toolsuite, such as, the Generic Modeling Environment (GME) 101 or other suitable modeling environment that provides a visual language for describing composition rules for models in a particular domain, and automatically generates a visual modeling environment for that domain. The GME-Integrated Forecasting Toolkit (GIFT) as disclosed herein provides seamless transitions into a completely service oriented architecture where all components interact with other components through well-defined service interfaces using open, platform-independent standards and protocols. The GIFT enables increased levels of reuse of legacy tools and data sources using wrappers (e.g., interfaces) that mediate between incoming service requests and actual tool implementation.

As shown in FIG. 1, the GIFT can include a GME front end 102, a model database 104, and a forecasting program or tools 106. The GME front-end 102 can include a generic GME toolsuite configured to operate in a specific domain, such as oilfield asset modeling, or other suitable domain as desired. The front-end 102 provides for specifying and manipulating information about various entities such as wells, reservoir volume elements, surface facilities, or other entities as desired. The front-end 102 can also be the launching point for different analysis applications that include scenario comparison, oil production forecasting, or other suitable analysis programs as desired.

The model database 104 can be configured to include a set of files that hold actual information regarding components in a domain that are specified by an end user through the GME front-end 102. The model database 104 can be implemented in memory or in a hard disc, or other suitable storage means. A user can update the model database 104 by committing the changes to the model database 104, which involves exporting the model from the front-end 102 to the model database 104. In an exemplary embodiment, a user can also update the model database using integrated tools provided in the front-end 102 and by importing an updated model into the modeling environment from other applications. In another exemplary embodiment, a publish/subscribe event-triggered mechanism can be used by components to register an interest in a particular subset of the model data and provide a callback function that is automatically invoked when a change in the data set occurs. The GIFT can be configured such that a common copy of the model database 104 is shared among the GIFT components so that updates of the model database 104 made by one component are immediately visible throughout the framework.

The forecasting program 106 can be automatically invoked for a selected model through GME front-end 102. The forecasting program 106 can be a standalone application or group of applications (i.e., tool kit) that reads the required input data from the model database 104. The only configuration information that is passed to the forecasting program 106 is the name of the scenario that is to be forecast. The retrieval of the scenario data from the model database 104 can be performed independently by the forecasting program 106. As a result, for any changes or modifications to a selected model to take effect, the modified model must be imported back into the modeling environment. The forecasting program 106 is not coupled with the GME environment, and allows a user to inspect model data through a set of custom-designed MS Windows Forms, or any other tools suitable for inspecting the model data in an operating system, and allow manipulation of data through a forms interface. The forms summarize the data input through the front-end 102.

The GIFT can be implemented through a domain-specific modeling language, such as Unified Modeling Language (UML) or any suitable modeling language as desired. The modeling language provides a common vocabulary for domain-experts to define and “understand” an asset model, and forms the basis for various tools (e.g., forecasting program 106) to navigate the model database and retrieve and update specific model parameters. In exemplary embodiments, the domain-specific modeling language can be configured to describe a generic oilfield asset, or other suitable domain as desired. One of ordinary skill will appreciate that the modeling language can be configured to describe all physical and non-physical model information that acts as an input to the integrated forecasting workflow.

The GIFT modeling language can be expressive enough to allow for the representation of a variety of assets using the same modeling paradigm. Tools for importing models from or exporting models to the model database, and even the forecasting program 106, can be used unmodified for any other asset represented in this paradigm.

In exemplary embodiments, the data objects in an oilfield asset model can be classified into physical and non-physical components. Physical components can include components, such as wells, reservoir volume elements, separators, compressors, or other suitable components as desired. Non-physical components can include components, such as production controls, field constraints, drilling schedules, reliability models, and other suitable components as desired.

The GIFT executes a workflow based on an inventory concept and a scenario concept. An inventory is a library of building blocks that are used to compose a scenario. The purpose of creating an inventory of immutable model elements and attributes is to be able to define these elements only once and include them by reference in each scenario. Once the components of an asset are described or modeled within the inventory, the end-user can focus on the analysis of different scenarios for the asset.

Inclusion of a component by reference to the inventory entity can enable any change made to some component of the model inventory to be instantly reflected in each scenario that contains that component. For example, if a given asset has five (5) reservoir volume elements (blocks), and 20 wells per block, each scenario can be configured to assign a different functionality to a different subset of the wells (i.e., a well which is configured for water injection in one scenario might be modeled as a producer in another scenario, and one scenario might model only four of the five blocks for forecasting purposes, and another might model all five). Despite the manner in which each scenario is configured, basic properties of an asset such as the location and name of each well, the well-to-block association, and the fluid region properties of each block, for example, remain substantially unchanged.

In another exemplary embodiment, asset modeling can be configured without an inventory model. Under this configuration, a template of possible model elements can be provided to the end user so that the end user can manually construct each scenario by instantiating the desired number and relationship of model elements, setting the attributes of each element to reflect the reality of the asset, and then running the forecasting program 106 on the scenario as configured.

Although asset modeling can be successfully achieved whether the inventory model is included or not, the with-inventory approach provides a reduced cost of scenario and cost of change. For example, if each scenario has to be constructed from scratch, the cost of scenario definition is less using the with-inventory approach because much of the definition already exists in the inventory such that the number of scenarios that can be defined and analyzed in a given time becomes significantly reduced. In another example, a hundred scenarios are defined for each of the with-inventory and without-inventory approaches, and each scenario includes a well (W1) with a production capacity of 1000 m³/day, where the production capacity influences the output of production forecasting. If the capacity of the well changes to 1500 m³/day, all scenarios require a rerun and the capacity attribute of the well W1 should be updated in each scenario. The with-inventory approach requires a single update to the W1 entity in the inventory, and this change is implicitly reflected in each scenario that contains a pointer (e.g., reference) to W1. On the other hand, the without-inventory approach requires that each of the hundred scenarios be updated manually.

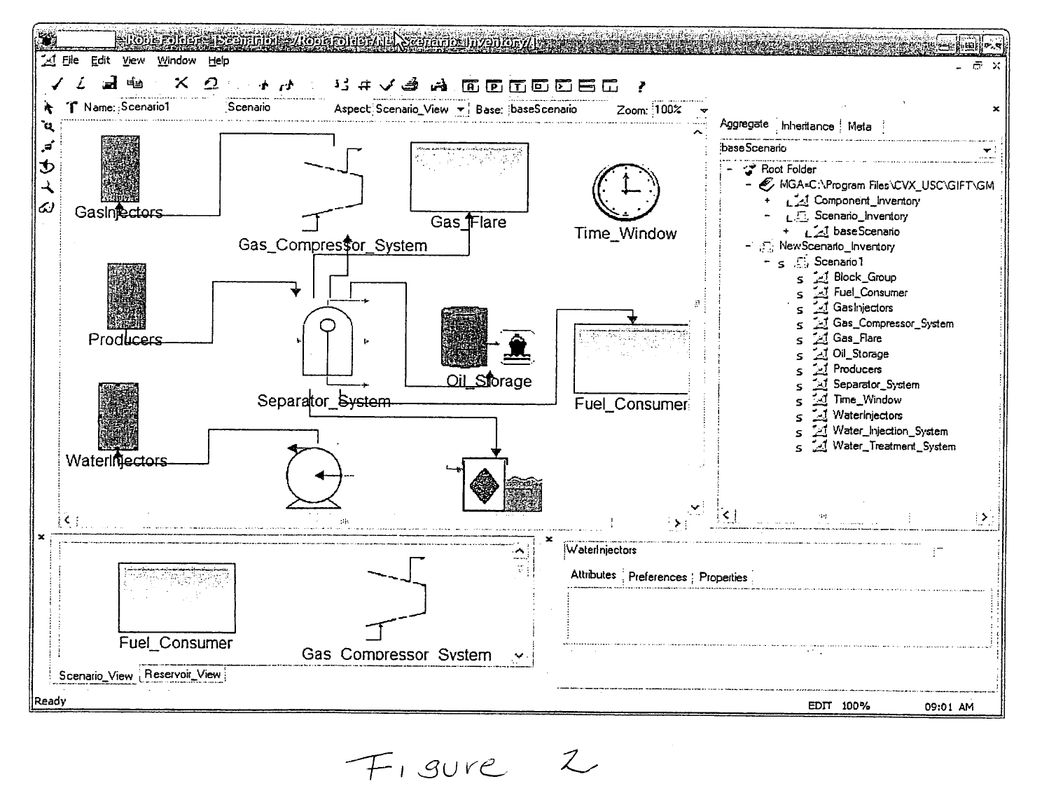

FIG. 2 illustrates a root folder view of a graphical interface in accordance with an exemplary embodiment. As shown in FIG. 2, the GME front end 102 can be configured to provide a graphical user interface that is used to instantiate, inspect, and modify inventory and scenario models. The scenario models include representations of gas injectors, producers, water injectors, a gas flare, oil storage, and fuel consumer. This scenario also includes models of a gas compressor system and a separator system. The front end 102 stores the model information in a format that is programmatically accessible. The model data can be stored as a set of extensible markup language (XML)-formatted text files, unstructured text files, a relational database (e.g., Oracle or SQL Server), or a combination thereof, which established the model database 104. In an exemplary embodiment, the model database 104 is implemented in an XML format. XML is readable by humans and through a text editor, can provide easy manipulation of the data stored in the XML files. One of ordinary skill will appreciate that the model database can be stored within or outside the GME environment as desired. Storing the model data in this manner provides standardization and open, platform-independent access to the model database 104.

Under this configuration, the forecasting program 106 or other exemplary tools, which are integrated into the GIFT, read and write model data to and from the model database 104. As a result, multiple tools can work on the same model in a coordinated manner, which eliminates the need to write adapters for tools to communicate directly with each other. Furthermore, this configuration establishes the GME modeling environment as an additional tool in the GIFT that is at the same layer as the forecasting program 106. If a different model visualization and manipulation interface is implemented, it can be plugged into the framework to replace or complement the GME environment without requiring any modification to the existing infrastructure.

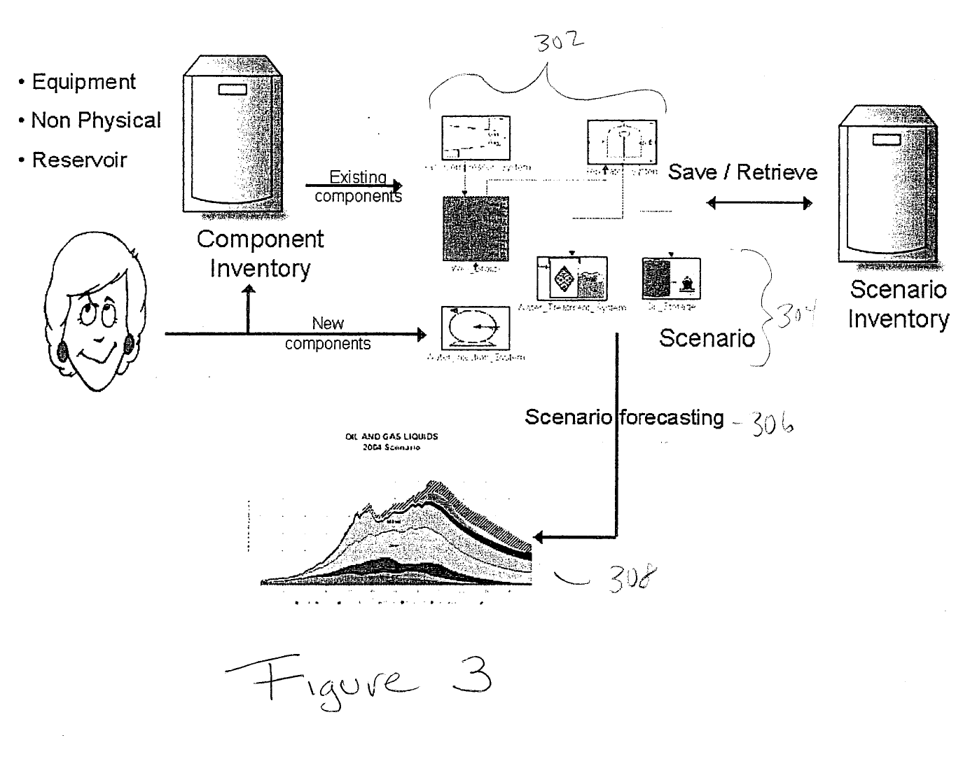

FIG. 3 illustrates a schematic diagram of an integrated forecasting workflow in accordance with an exemplary embodiment. To perform integrated forecasting, the GIFT can be configured to include phases such as asset modeling 302, scenario modeling 304, forecasting 306, and inspection of the output 308 for possible scenario refinement and/or decision-making.

The asset modeling phase 302 can include instantiation of model elements that represent the structure and properties of the asset. For small assets, the model instantiation can be performed manually. For larger assets, where manual modeling is not realistic or desirable, the GIFT provides an automatic model synthesis mechanism that reads legacy data and automatically creates suitable entries in the modeling environment. The automatic model synthesis provides an advantage in that the end user may spend less time on model entry and more time on scenario planning and analysis. Once the inventory model is finished, the scenarios are defined. The scenarios are then committed (e.g., saved) to disk, and the forecasting program 106 is launched.

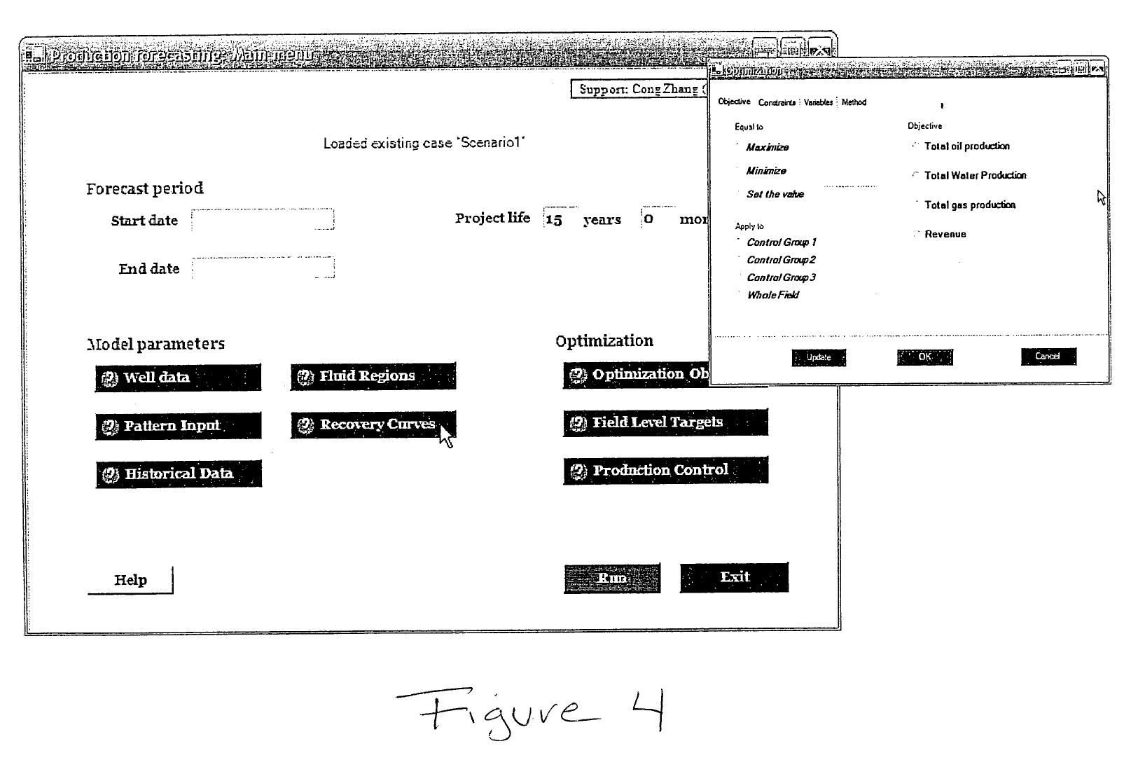

FIG. 4 illustrates a production forecasting menu of a graphical interface in accordance with an exemplary embodiment. When the forecasting program 106 GIFT completes the forecast, the user has the option of selecting a format of the output. The forecasting program 106 can be configured to output results in various formats such as unstructured ASCII text or as a spreadsheet (e.g. Excel), or any other suitable output format as desired. In exemplary embodiments, the asset model can be configured to include model elements that capture a scenario configuration as well as pointers to a forecasting output. As a result, the forecasting program 106 can feed the forecasting output back into the model database 104 so that the output can be accessed by other components (e.g., applications) of the GIFT framework.

Related application Ser. No. ______ filed on Apr. 11, 2007 and entitled “A System and Method for Oil Production Forecasting and Optimization in a Model-Based Framework”, application Ser. No. 11/505,163 filed on Aug. 15, 2006 and entitled “Method and System for Integrated Asset Management Utilizing Multi-Level Modeling of Oil Field Assets”, and application Ser. No. 11/505,061 filed on Aug. 15, 2006 and entitled “Modeling Methodology for Application Development in the Petroleum Industry” are all commonly assigned, and the contents of each related application is hereby incorporated in its entirety by reference.

While the invention has been described with reference to specific embodiments, this description is merely representative of the invention and not to be construed as limiting the invention. Various modifications and applications may occur to those skilled in the art without departing from the true spirit and scope of the invention as defined by the appended claims.

Related application Ser. No. 11/734,221 filed on Apr. 11, 2007 and entitled “A System and Method for Oil Production Forecasting and Optimization in a Model-Based Framework”, application Ser. No. 11/505,163 filed on Aug. 15, 2006 and entitled “Method and System for Integrated Asset Management Utilizing Multi-Level Modeling of Oil Field Assets”, and application Ser. No. 11/505,061 filed on Aug. 15, 2006 and entitled “Modeling Methodology for Application Development in the Petroleum Industry” are all commonly assigned, and the contents of each related application is hereby incorporated in its entirety by reference.

1. A system for forecasting oilfield production in an integrated asset management framework, the system comprising:
a graphical interface for generating a plurality of models that represent asset components in the oilfield and specifying conditions associated with the plurality of models;
a model database for storing the plurality of models; and
an application toolkit for analyzing at least one of the plurality of stored models based on the conditions to forecast a performance of an asset component associated with the at least one analyzed model.

2. The system of claim 1, wherein the asset components comprise physical and non-physical assets.

3. The system of claim 2, wherein the physical asset components comprise pumps, subterranean reservoirs, pipe network systems, well bores connecting the reservoirs to pipe network systems, separators, processing systems for processing fluids produced from the subterranean reservoirs and heat and water injection systems.

4. The system of claim 2, wherein the non-physical asset components comprise reliability estimators, production controls, field constraints, and drilling schedules.

5. The system of claim 1, further comprising an inventory model for instantiating a desired number and relationship of model elements and setting attributes of each model element to reflect a reality of the asset.

6. The system of claim 5, wherein the inventory model defines the scenario.

7. A method of integrated forecasting in an integrated asset management framework, the method comprising:
instantiating model elements of an asset component to generate an inventory model of an asset;
defining at least one scenario based on the inventory model; and
analyzing the at least one scenario to forecast a performance of the asset.

8. The method of claim 7, further comprising classifying the model elements as physical or non-physical components.

9. The method claim 7, wherein the instantiating step further comprises:
reading legacy data associated with an asset.

10. A computer readable medium storing a program for performing a method of integrated forecasting in an integrated asset management framework, the method comprising:
instantiating model elements of an asset component to generate an inventory model of an asset;
defining at least one scenario based on the inventory model; and
analyzing the at least one scenario to forecast a performance of the asset.
